(19) United States
(12) Patent Application Publication
(10) Pub. No.: US 2022/0366026 A1
(43) Pub. Date: Nov. 17, 2022

(54) Using Multi-Factor Authentication as a Labeler for Machine Learning- Based Authentication

(71) Applicant: TWOSENSE, INC., Brooklyn, NY (US)

(72) Inventors: Dawud Gordon, Brooklyn, NY (US); John Tanios, Brooklyn, NY (US); Oleksii Levkovskyi, Brooklyn, NY (US); Joshua Bergeron, New York, NY (US); Jolene Dunne, Brooklyn, NY (US)

(21) Appl. No.: 17/767,040

(22) PCT Filed: Oct. 19, 2020
(86) PCT No.: PCT/US2020/056295

§ 371 Date: Apr. 6, 2022

Related U.S. Application Data
(60) Provisional application No. 62/916,637, filed on Oct. 17, 2019.

(51) Int. Cl. G06F 21/31; G06F 21/32; G06N 20/00

(52) U.S. Cl. CPC G06F 21/316; G06F 21/32; G06N 20/00

(57) ABSTRACT

Machine learning-based authentication (MLBA) techniques may provide great advantages when combined with manual authentication methods. The contribution consists of detecting phenomena that are co-occurring with, or causally related to, both valid and invalid authentication attempts. Models may be built to detect those events by training them using labeled data. Acquiring labels is traditionally a difficult manual process that is human effort intensive. This invention solves that problem by leveraging multi-factor authentication as a tool to automate labeling.

### RELATED APPLICATION

This application claims the benefit of the following U.S. Provisional Patent Application, which is incorporated by reference in its entirety:

1) Ser. No. 62/916,637, filed on Oct. 17, 2019.

### BACKGROUND

Machine learning-based authentication (MLBA) techniques may provide great advantages when combined with manual authentication methods. The contribution consists of detecting phenomena that are co-occurring with, or causally related to, both valid and invalid authentication attempts. Models may be built to detect those events by training them using labeled data. Acquiring labels is traditionally a difficult manual process that requires intensive human effort.

This disclosure solves that problem by leveraging multi-factor authentication as a tool to automate labeling.

### SUMMARY

Other inventions require manual effort and human-in-the-loop or assume that all behavior observed historically is authorized behavior.

Other solutions either only scale with human effort or make errors by potentially incorporating unauthorized behavior into the positive data set, thereby reducing system accuracy and security.

This disclosure improves on existing solutions by using software and/or hardware to label data to improve security and performance of the system.

### BRIEF DESCRIPTION OF THE DRAWINGS

The accompanying figure together with the detailed description below, are incorporated in and form part of the specification, serve to further illustrate embodiments of concepts that include the claimed invention and explain various principles and advantages of those embodiments.

FIG. 1 is a schematic of components as an embodiment of the present invention.

FIG. 2 is a schematic of steps as an embodiment of the present invention.

Skilled artisans will appreciate that elements in the figure is illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawing, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The foregoing descriptions, formulations, diagrams, and figures are provided merely as illustrative examples, and they are not intended to require or imply that the steps of the various embodiments must be performed in the order presented or that the components of the invention be arranged in the same manner as presented. The steps in the foregoing descriptions and illustrations may be performed in any order, and components of the invention may be arranged in other ways. Words such as “then,” “next,” etc., are not intended to limit the order of the steps or the arrangement of components; these words are used merely to guide the reader through the description of the invention. Although descriptions and illustrations may describe the operations as a sequential process, one or more of the operations may be performed in parallel or concurrently, or one or more components may be arranged in parallel or sequentially. In addition, the order of the operations may be rearranged.

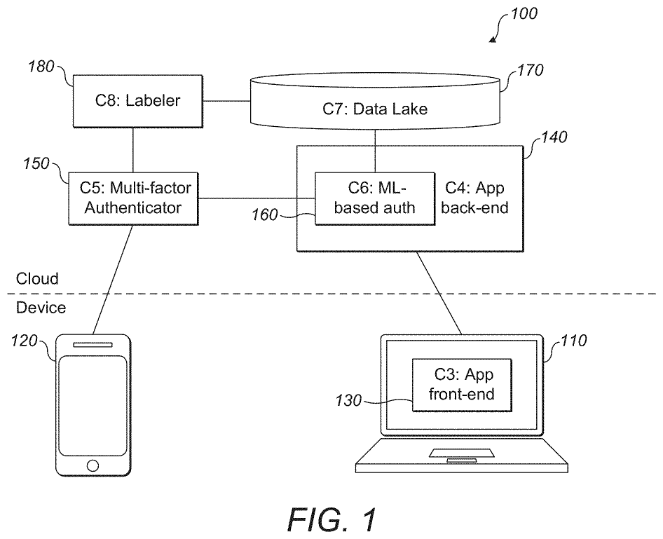

Turning to FIG. 1, shown is a schematic 100 of components (Cx), namely:

C1—primary device 110;

C2—Secondary device 120;

C3—App Front-end 130;

C4—app Back end 140;

C5—Multi-factor authenticator 150;

C6—Learning-based authenticator 160;

C7—Data Lake 170; and

C8—Labeler 180.

Further details about the components follow.

C1: primary device 110—This is an off-the-shelf user devices such as a laptop, phone, tablet, watch, ATM, vehicular user interface, etc. which provides access to an application user interface.

C2: secondary device 120—same as Cl 110.

C3: app front-end 130—this is the user interface to an application on C1 110. Any device providing access to a user interface may be seen at that moment as a primary device. This may be a native application installed on C1 110 but is more often than not a web application with its UI provided through a browser.

C4: app back-end 140—this is the application logic for C3 130. This may often be hosted on the cloud and often integrated with other apps and services.

C5: multi-factor authenticator 150—this is a piece of software and/or hardware that uses two of the following authentication methods to confirm user identity: a shared secret, a known device, or a biometric attribute. Often the application will implement a password, and this app will confirm the user with a biometric prompt on the secondary device. It often has a backend of its own as well as a user interface.

C6: learning-based authenticator 160—this is a system that learns to recognize phenomena correlated with authorized usage of the application. This requires observation of those phenomena, and then parameter fitting to differentiate authorized from unauthorized phenomena. Those phenomena are stored in the data lake. The learning-based authenticator is trained with a history of observations which are labeled with positive and negative results, allowing C6 to predict the outcome of multi-factor authentication (MFA) from observed phenomena.

C7: data lake 170—this is a data store, often in the cloud, that contains recorded phenomena as well as which phenomena are correlated to authorized and unauthorized authentications for each user. This provides the basis for building the learning-based system, as well as label storage.

C8 labeler 180—this systems is connected to the MFA application C5 150. Whenever C6 160 observes phenomena that results in a negative authentication result, it pings C5 150 to execute a manual (meaning user-in-the-loop) MFA challenge. The results, or outcome, of that MFA challenge are then communicated to the labeler 180, which then annotates the observations where they are recorded in the data lake, usually with 0 or ‘False’ for failed, 1 or ‘True’ for success.

Components relate to each other through software, API and network connectivity. Applications are either installed on devices or accessed through a web browser.

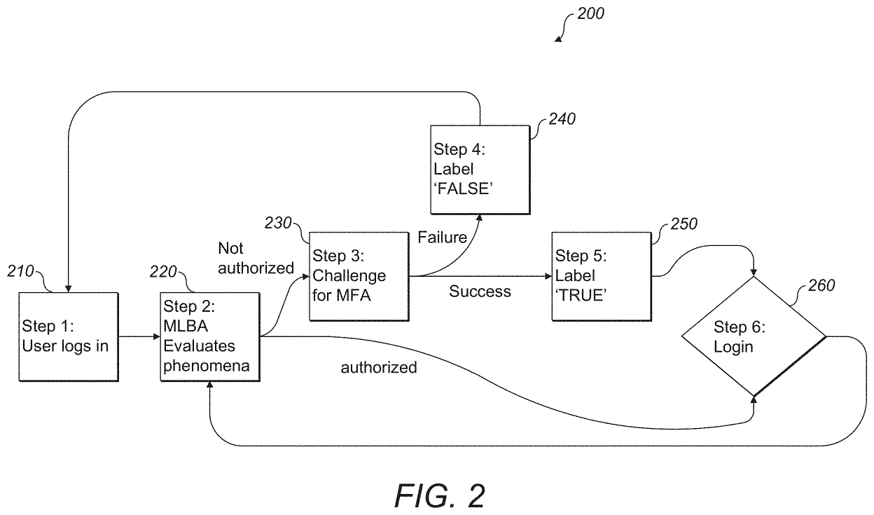

Turning to FIG. 2, shown is a schematic 200 of steps (Sx), namely:

Step 1 210—user attempts to log in, or execute a task on device Cl using app C3;

Step 2 220—Learning component determines if the observed and modeled phenomena appears authorized or unauthorized;

Step 3 230—System challenges for MFA;

Step 4 240—If MFA fails a negative label is created for phenomena;

Step 5 250—if MFA succeeds the labeler 180 labels the data that prompted S3 230 to provide a negative result with a positive label in the data lake C7; and

Step 6 260—user allowed to log in or execute task.

If S2 220 is successful, the user may progress to S6 260. If S3 230 fails, the behavior receives a negative label.

After S4 240, the system may revert to S1 210, S2 220, or S3 230.

After S6 260, the system may revert to S2 220 infinitely while the user is interacting with the system.

C1 110 and C2 120 may be created using a standard laptop and mobile phone respectively.

Building a simple webapp that requires a username and password (C3 130 and C4 140).

Incorporating a time-based one-time password (TOTP) may be the second factor into the webapp. This may be done by leveraging open-source resources such as this one: github.com/pyauth/pyotp.

Using this library, at user enrollment, use the above library to generate a secret code that may be enrolled in a mobile app which may then be used to generate TOTPs.

The mobile component may be downloaded from the play store, such as the

### Google Authenticator App.

Then at login, prompt the user to enter a code generated by the mobile app, and validate it with the above library, before allowing them to proceed.

Together these steps represent first (password) and second (device) factors, which combine to create multi-factor authentication C5 150.

To implement C6 160, a second authenticator may be created. A simple implementation of the learning component may be created by looking that the time it takes to type the password. For each login: a) record the length of time it takes the user to type the password (the phenomena); and b) hash the user ID and insert those values together into a table in C7 170 with the label set to False. To train C6 160, compute the mean and standard deviation (sigma) of those times which are labeled with ‘True’ by the labeler 180 and store them in memory. These values represent a Probability Density Function (PDF). At authentication time, if the time the user takes to type the password is within one sigma of the mean, allow them to enter the app, otherwise send the user to a screen to enter the TOTP.

Component C8 180, the labeler 180 may then be used by connecting it to the TOTP screen as well. If the user enters the correct TOTP, the labeler 180 updates the records by finding the most recent timestamp for the user ID hash and setting the value of the label to ‘True’.

C7 170 may be implemented using any standard database implementation.

The MLBA may be in the app backend, in the app front-end, or separate system with its own agent on devices C1 110, C2 120 and/or others, or part of the OS or another agent of the devices or cloud infrastructure.

MFA may be built into apps C3 130 and C4 140, does not require a second device (password plus biometric).

App may implement a single factor (e.g. password or biometric) that is used as both authenticator and labeler 180 input without MFA.

There may also be no MFA, just a combination of in-app auth and MLBA.

Learning component may be on-device only (C1 110 and C2 120), with no data lake component, in which case the labeler 180 will feed back to device. MFA may also be a cloud or on device component, and the labeler 180 may also be used on device or in the cloud.

C2 120 may not be a mobile device, but a hardware authenticator built solely for that purpose such as a Yubikey or Google Titan.

C6 160, the MLBA, may not be a separate agent at all but may be embedded in the operating system of primary and/or secondary devices.

C1 110 and C2 120, primary and secondary devices, may arbitrarily switch roles.

The labeler 180 may feed directly back into the learning-based authenticator, which may adapt without requiring a data lake.

Any and all components may be located in the cloud or on device.

The system may be connected to an identity provider and policy manager that controls both the user identity as well as all personally identifiable information (PII), such that C6 160 does not use, contain or require PII to make a decision.

MFA challenges may be sent periodically even on correct behavior to gather further labels and spot-check results.

The MLBA may use phenomena from other users, even of other applications, to gain insight into both authorized and unauthorized behavior of the user in question at any time.

The MLBA may also be used continuously after authentication and during system use. It would stop interaction and/or challenge for MFA if phenomena observed indicates that this action is wise, which would again create input for the labeler 180 based on the outcome of that challenge.

The MFA and MLBA, as well as the labeler 180, may all be contained within a single application, which may all be integration into the main application. The multi-factor authentication may consist of the shared secret plus two-factor authentication implementation described but may also be a hardware/software biometric.

The second factor may be frictionless, such as turning on a camera for facial recognition (third factor) or detecting the authorized user's device for proximity as a second factor.

The MLBA may incorporate biometric inputs such as behavioral or facial images.

The learning-based authenticator and labeler 180 may be used for device operating system authentication instead of authenticating application identity.

The MLBA may use external phenomena for authentication instead or in addition to app or system-internal phenomena, such threat intelligence feeds or social media analysis.

The authenticators (MFA, MLBA, passwords, etc.) may grant access to unauthorized users in a sandboxed environment to provide the labeler 180 C8 with input from attackers.

The labeler 180 may label further types of labels beyond authorized and unauthorized, such as attacker, guest, new user, credential change, or locality information, device ID, MFA meta information, level of attack sophistication, etc.

The labeler 180 may also output labels to 3rd party systems such as a SIEM.

The labeler 180 may also be connected to the components of the MLBA that do phenomena observation, inputting the observations with labels into the data lake.

The labeler C8 180 may be on device, part of the MFA app, part of the C3 130 or C4 140, or completely remote connecting via APIs.

The MLBA and/or the labeler 180 may operate outside the user's interaction with the app or the devices.

Continuous MLBA with labeling may be used for continuous learning, leading to continuous security system improvement and adaptation to user changes and threats over time.

The MLBA may be used primarily, meaning as the first line of defense before any other form of authenticator such as a password. It may also be contained in a separate application on either C1 110 or C2 120 or both, or be part of the OS of those devices.

MFA, MLBA and labeler 180 may all be integrated into a Single Sign-On environment.

The MLBA may be used to decide which form of MFA, and/or how many factors, are used, that than as a factor itself.

The labeler 180 may not be integrated into MFA, but only be integrated into the application or the device and combine knowledge of the MLBA's negative output with successful application or device sign-in to infer successful MFA for labeling.

The application may also be human interaction, over the phone or in person, or through another system beyond human-computer interaction.

All authenticators may be used during app usage, rather than at the beginning of interaction.

The MLBA may also be used to divert unauthorized users to a different application that may mimic C3 130/C4 140. The observed phenomena there may then be labeled as attacker or threat observations.

The labeled data and MLBA outputs may be used to judge organizational and individual threat and risk levels.

Labeled data may also be used for product improvements and to guide developer roadmaps, and to give security and risk tips.

Using MLBA with the labeler 180 continuously, combined with continuous learning, may eliminate spear phishing and other forms of cyber-attack that compromise identity security

The results of this invention may be used to discover causal relationships between phenomena and authorization.

Alternatively, authentication labels may be used to infer phenomena instead of using phenomena to infer authorization or authentication.

The preceding description and illustrations of the disclosed embodiments is provided in order to enable a person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. While various aspects and embodiments have been disclosed, other aspects and embodiments are possible. The various aspects and embodiments disclosed are for purposes of illustration and are not intended to be limiting.

The foregoing descriptions, formulations, diagrams, and figures are provided merely as illustrative examples, and they are not intended to require or imply that the steps of the various embodiments must be performed in the order presented or that the components of the invention be arranged in the same manner as presented. The steps in the foregoing descriptions and illustrations may be performed in any order, and components of the invention may be arranged in other ways. Words such as “then,” “next,” etc., are not intended to limit the order of the steps or the arrangement of components; these words are used merely to guide the reader through the description of the invention. Although descriptions and illustrations may describe the operations as a sequential process, one or more of the operations may be performed in parallel or concurrently, or one or more components may be arranged in parallel or sequentially. In addition, the order of the operations may be rearranged.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. (canceled)

2. A system comprising:
a primary device, which provides access to an application user interface for an application;
a secondary device, which provides access to the application user interface for the application;
an app frontend, which provides user access to the primary device;
an app backend, which provides application logic for the app frontend;
a multi-factor authenticator, which confirms identity of a user for the application;
a learning-based authenticator, which learns to recognize phenomena correlated with authorized use and unauthorized use of the application;
a data lake, which stores the phenomena correlated with authorized use and unauthorized use of the application authentications for the user; and
a labeler; which is connected to the multi-factor authenticator and annotates the phenomena correlated with authorized use and unauthorized use of the application authentications for the user.

3. The system as in claim 2, wherein the app front end is a web application with user interface provided through a browser.

4. The system as in claim 2, wherein the multi-factor authenticator uses at least two of: a shared secret, a known device, and a biometric attribute.

5. The system as in claim 2, wherein the learning-based authenticator is trained with a history of observations labeled with positive and negative results.

6. A method comprising:
a user exhibiting an observable phenomenon when attempting to execute a task on a device using an app;
a learning component determining if the observable phenomenon appears authorized or unauthorized;
a system challenging the user via multi-factor authentication using the device;
if the multi-factor authentication fails after the learning component determines that the observable phenomenon appears unauthorized, creating a negative label for the observable phenomenon in a data lake associated with the app;
if the multi-factor authentication succeeds after the learning component determines that the observable phenomenon appears unauthorized: (a) creating a positive label for the observable phenomenon in the data lake; and (b) allowing the user to execute the task on the app.

7. The method as in claim 6, wherein the observable phenomenon is a biometric input.

8. The method is in claim 6, further comprising the learning component determining if the user is at least one of: an attacker, guest, and new user.

9. The method is in claim 6, further comprising the learning component collecting information about at least one of the following events: credential change, locality information, device ID, multi-factor authentication meta information, and level of attack sophistication.

10. The method as in claim 7, wherein the observable phenomenon further comprises the user's device for proximity detection.

11. The method as in claim 6, further comprising:
outputting the positive label and the negative label to a third-party system.

12. The method as in claim 6, further comprising:
if the multi-factor authentication fails after the learning component determines that the observable phenomenon appears unauthorized, diverting the user to a different application.

13. The method as in claim 6, wherein the learning component consults a threat intelligence feed when determining if the observable phenomenon appears authorized or unauthorized.

14. The method as in claim 6, further comprising:
if the multi-factor authentication succeeds, periodically challenging the user again via a set of second multi-factor authentications.

15. A method comprising:
a user exhibiting an observable phenomenon when attempting to execute a task on a device using an operating system;
a learning component determining if the observable phenomenon appears authorized or unauthorized;
a system challenging the user via multi-factor authentication using the device;
if the multi-factor authentication fails after the learning component determines that the observable phenomenon appears unauthorized, creating a negative label for the observable phenomenon in a data lake associated with the operating system;
if the multi-factor authentication succeeds after the learning component determines that the observable phenomenon appears unauthorized: (a) creating a positive label for the observable phenomenon in the data lake; and (b) allowing the user to execute the task.

16. The method as in claim 15, wherein the observable phenomenon is a biometric input.

17. The method is in claim 15, further comprising the learning component collecting information about at least one of the following events: credential change, locality information, device ID, multi-factor authentication meta information, and level of attack sophistication.

18. The method as in claim 16, wherein the observable phenomenon further comprises the user's device for proximity detection.

19. The method as in claim 15, further comprising:
if the multi-factor authentication fails after the learning component determines that the observable phenomenon appears unauthorized, diverting the user to a different application.

20. The method as in claim 15, wherein the learning component consults a threat intelligence feed when determining if the observable phenomenon appears authorized or unauthorized.

21. The method as in claim 15, further comprising:
if the multi-factor authentication succeeds, periodically challenging the user again via a set of second multi-factor authentications.
